(19) United States
(12) Patent Application Publication
(10) Pub. No.: US 2011/0309064 A1
(43) Pub. Date: Dec. 22, 2011

(54) RADIO-FREQUENCY HEATING APPARATUS WITH RANGE HOOD

(75) Inventor: Hiroshi Sumi, Nara (JP)

(73) Assignee: PANASONIC CORPORATION, Kadoma-shi, Osaka (JP)

(21) Appl. No.: 13/201,170

(22) PCT Filed: Feb. 17, 2010
(86) PCT No.: PCT/JP2010/000964

§ 371 Date: Aug. 11, 2011

(30) Foreign Application Priority Data
Feb. 25, 2009 (JP) 2009-041947

(51) Int. Cl. H05B 1/00

(52) U.S. Cl. 219/220

(57) ABSTRACT

A radio-frequency heating apparatus with a range hood includes: a radio-frequency heating device having a range hood; a plurality of lighting lamps (41 42) for lighting under the radio-frequency heating device; and dimming device (49) provided with TRIAC (44) for controlling luminance of lighting lamps (41, 42), wherein the plurality of lighting lamps (41, 42) are connected in series. With this arrangement, even if a short-circuiting failure occurs in one of the lamps, the inside resistance of the other lamp can restrict a short-circuiting current, thereby preventing an overcurrent from flowing in dimming device (49) during short-circuit.

### TECHNICAL FIELD

The present invention relates to a radio-frequency heating/cooking apparatus with a range hood for use in a limited space.

### BACKGROUND ART

A conventional radio-frequency heating apparatus with a range hood of this type is provided with a luminaire at a bottom surface of a radio-frequency heating apparatus body. A dimmer for adjusting the luminance of the luminaire dims a luminance by using a semiconductor device such as a TRIAC (refer to, for example, Patent Literature 1).

Some of dimming devices for cookers determine whether either one or both of two lamps are lighted by using relays so as to control luminance (refer to, for example, Patent Literature 2).

FIG. 3 is a diagram illustrating a conventional dimmer disclosed in Patent Literature 1. The conventional dimmer illustrated in FIG. 3 includes TRIAC 1, load 2 (which is an incandescent lamp in this case), control circuit 3, and AC voltage supply terminals 4 and 5 serving as load power sources. Control circuit 3 controls a voltage to be supplied to TRIAC 1, thereby controlling luminance.

FIG. 4 is a diagram illustrating a configuration of an electric circuit for a conventional cooker disclosed in Patent Literature 2. As illustrated in FIG. 4, the electric circuit includes lamps 11 and 12 and relay contacts 33a and 34a for controlling the lighting of the lamps, respectively. Relay contacts 33a and 34a are connected via door switches 22a and 22b onto a primary coil side of high voltage transformer 23 having magnetron 26 connected thereto on a secondary coil side. Lamps 11 and 12 are controlled to be lighted or extinguished via relay contacts 33a and 34a by switching door switches 22a and 22b.

A dimming system using the conventional TRIAC confronts the following problems to be solved: a frequent generation of an overcurrent at the time of expiration of the lifetime of the lamp causes an accident of a failure of the TRIAC. The generation of an overcurrent due to the failure of the lamp is liable to be caused by short-circuit due to matters flying between terminals of an electrode when a filament of the incandescent lamp is broken. The TRIAC including a semiconductor is less resistant against the overcurrent, and therefore, component parts may be broken.

In this manner, the conventional arrangement using the TRIAC, disclosed in Patent Literature 1, has a problem to be solved of the failure of the TRIAC due to the overcurrent.

Moreover, relay contacts 33a and 34a in the dimmer using the relays, disclosed in Patent Literature 2, is relatively more resistant against a short-circuiting current than the TRIAC, so that the problem of the failure of dimming per se can be overcome to a certain extent. However, an excessive current may break relay contacts 33a and 34a or a wire for connecting a relay.

In the case of the failure of the TRIAC or the relay, a radio-frequency heating/cooking apparatus need be detached from an upper place of a kitchen with much labor in order to repair the dimming device. In view of this, a decrease in failure rate in the dimming device has been required.

In addition, since only the lighting or extinguishing either one or both of the lamps is selected, there remains a problem to be solved that controlling luminance cannot be sequentially varied, unlike dimming using the TRIAC.

PTL 1: Unexamined Japanese Patent Publication No. H11-3785

PTL 2: Unexamined Japanese Patent Publication No. H1-246785

### SUMMARY OF THE INVENTION

An object of the present invention is to reduce an overcurrent which is generated due to the failure of a lamp so as to provide an arrangement for protecting a TRIAC or a thyristor for use in a dimming device from overcurrent breakage.

A radio-frequency heating apparatus with a range hood according to the present invention includes: a radio-frequency heating device having a range hood; a plurality of lighting lamps for lighting under the radio-frequency heating device; and a dimming device provided with a current control device for controlling luminance of the lighting lamps, wherein the plurality of lighting lamps are connected in series.

With this arrangement, it is possible to prevent any generation of an overcurrent due to a failure of the lamp so as to prevent a failure of the dimming device.

### BRIEF DESCRIPTION OF THE DRAWINGS

FIG. 1 is a general view illustrating a radio-frequency heating/cooking apparatus with a range hood according to an embodiment of the present invention.

FIG. 2 is a circuit diagram illustrating a luminaire in the radio-frequency heating/cooking apparatus with a range hood according to the embodiment of the present invention.

FIG. 3 is a circuit diagram illustrating an example of a conventional dimmer.

FIG. 4 is a circuit diagram illustrating another example of the conventional dimmer.

### DETAILED DESCRIPTION OF THE PREFERRED EMBODIMENTS

An embodiment according to the present invention will be described below with reference to the drawings. Incidentally, the present invention is not limited to the embodiment.

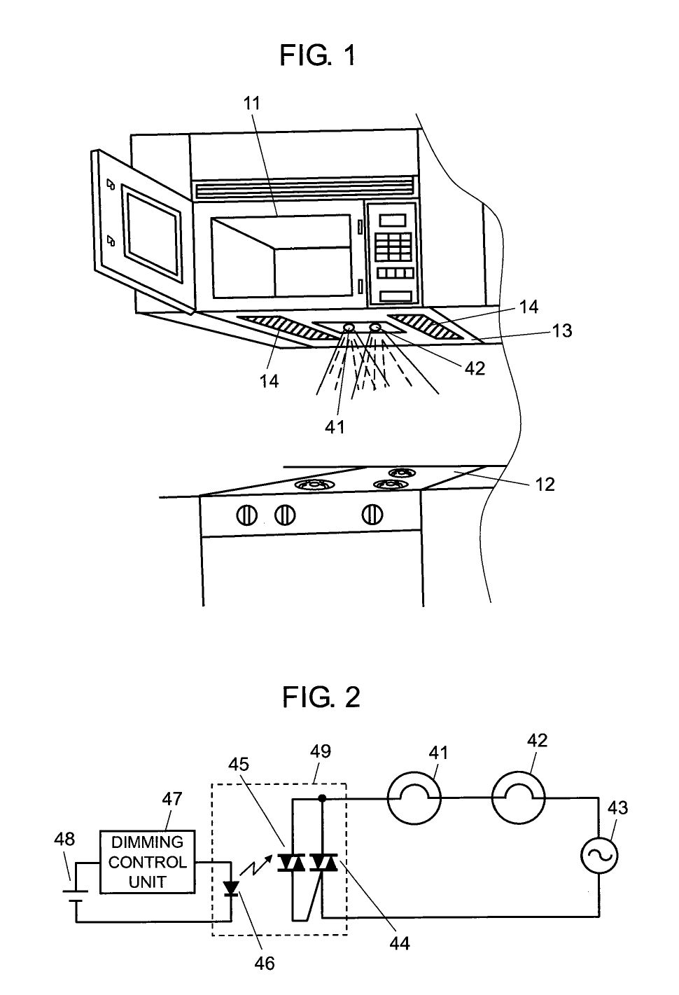

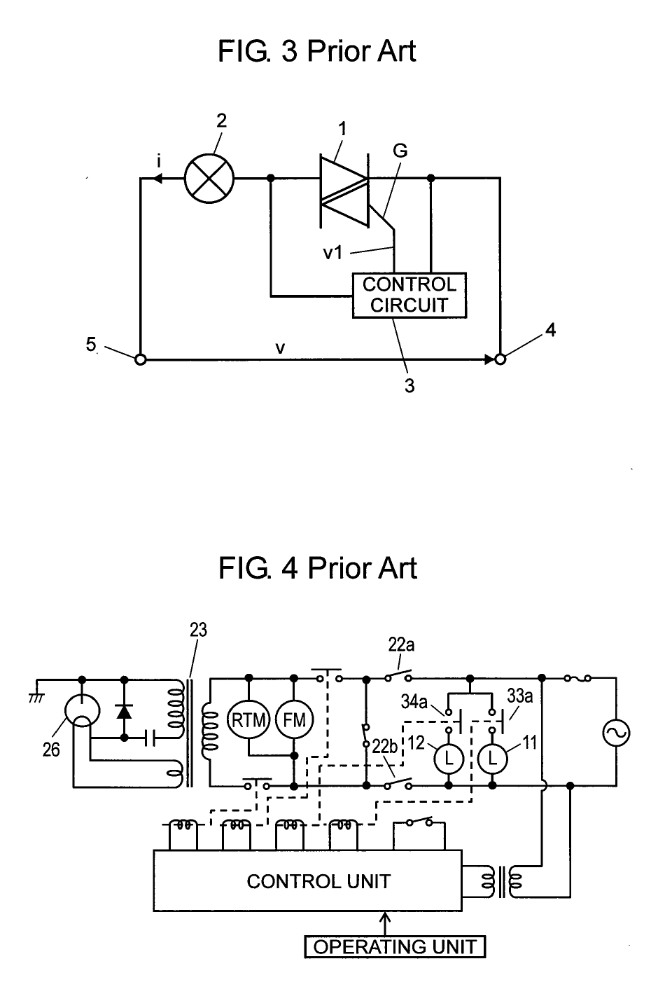

FIG. 1 is a general view illustrating a radio-frequency heating/cooking apparatus with a range hood according to an embodiment of the present invention. Referring to FIG. 1, radio-frequency heating apparatus 11 with a range hood according to the present embodiment is installed above cooking range 12. Radio-frequency heating apparatus 11 with a range hood has range hood 13 at the lower portion thereof, for exhausting air heated in cooking range 12 to the outside through intake ports 14. Range hood 13 incorporates therein first and second incandescent lamps 41 and 42 serving as lighting lamps.

FIG. 2 is a circuit diagram illustrating a luminaire in the radio-frequency heating/cooking apparatus with the range hood according to the embodiment of the present invention. Referring to FIG. 2, the two lamps, that is, first incandescent lamp 41 and second incandescent lamp 42 are connected in series with respect to load power source 43. This series connection including first incandescent lamp 41 and second incandescent lamp 42 is further connected in series to TRIAC 44. TRIAC 44 controls a current flowing in the incandescent lamps by repeatedly switching a circuit in a short period of time, thereby controlling the luminance of the lamp.

TRIAC 44 is connected to photo TRIAC 45, which is optically connected to light emitting diode 46. TRIAC 44, photo TRIAC 45, and light emitting diode 46 constitute dimming device 49. With this configuration, TRIAC 44 and photo TRIAC 45 are electrically insulated from dimming control unit 47 and controller power source 48 which are connected to light emitting diode 46.

In recent years, dimming device 49 has been called an SSR (Solid State Relay) which is one electronic part incorporating therein TRIAC 44, photo TRIAC 45, and light emitting diode 46, and thus, has actively replaced a relay, that is, a mechanical part.

A description will be given below of the operation of the luminaire in the radio-frequency heating/cooking apparatus with the range hood such arranged as described above. First, when the total power consumption of first incandescent lamp 41 and second incandescent lamp 42 is 60 W in the case where first incandescent lamp 41 and second incandescent lamp 42 illustrated in FIG. 2 are connected to load power source 43 of, for example 120 V, first incandescent lamp 41 and second incandescent lamp 42 individually come to serve as lamps which consume 30 W at 60 V.

Current I flowing in the lamp during lighting of the lamp is 0.5 A based on a relational equation: E×I=P (wherein E represents a load power source voltage of 120 V and P denotes a total power consumption of an incandescent lamp of 60 W). At this time, resistance R of each of incandescent lamps 41 and 42 is 120 W per lamp based on a relational equation: I×I×R=P/2.

In the present embodiment, in the case where the breakage of a filament during the lighting of first incandescent lamp 41 induces a failure of short-circuiting between electrodes by resultant fragments, circuit current I can be suppressed to 1 A to the maximum owing to inside resistance R of 120 W of second incandescent lamp 42 based on a relational equation: I=E/R (wherein E is 120 V and R is 120 Ω).

In other words, when the filament of first incandescent lamp 41 is short-circuited, the filament of second incandescent lamp 42 functions as an overcurrent preventing resistance in the present embodiment.

When a TRIAC having a maximum rating of 1 A is used in the circuit illustrated in FIG. 2, TRIAC 44 never fails even if one of the two lamps is accidentally short-circuited. Alternatively, if the two lamps are short-circuited at the same time, a very large short-circuiting current flows in TRIAC 44 from load power source 43. Consequently, the current flowing in TRIAC 44 instantaneously exceeds a rating current, and therefore, TRIAC 44 is broken. Such a phenomenon may least probably occur, and substantially, can never occur.

Normally, the above-described short-circuiting failure of incandescent lamps 41 and 42 occurs instantaneously, that is, in a short period of time, and therefore, the short-circuiting is seldom continued. Thus, there hardly occurs a phenomenon in which either one of the lamps is short-circuited whereas the other is continuously energized.

Consequently, a large overcurrent is never generated in dimming device 49 in the luminaire having the circuit arrangement according to the present invention even if a short-circuiting failure occurs in one of the incandescent lamps. Thus, dimming device 49 can be protected from any overcurrent.

That is, even if a short-circuiting failure occurs in the filament of one incandescent lamp, the resistance of the filament of the other lamp connected in series functions as the overcurrent preventing resistance capable of preventing any generation of an excessive short-circuiting current. Consequently, even if a short-circuiting failure occurs in the filament of one incandescent lamp, no overcurrent flows in the TRIAC for use in the dimming device, thus preventing any failure in the dimming device.

As described above, the radio-frequency heating apparatus with the range hood in the present embodiment can prevent any overcurrent which has conventionally been generated due to the failure of the lighting lamp so as to protect the TRIAC or a thyristor for use in the dimming device from overcurrent breakage. Additionally, the apparatus can be provided at a very reduced cost.

The configuration in which two or more incandescent lamps are lighted is described in the present embodiment. Therefore, a light emitting surface is large, so that convenience is enhanced without generation of a shadow of a person's hand during cooking in the radio-frequency heating/cooking apparatus with the range hood illustrated in FIG. 1. Furthermore, a single current control element is sufficient in dimming device 49, thereby providing the apparatus at a reduced cost.

As described above, the radio-frequency heating apparatus with the range hood according to the present invention includes: the radio-frequency heating device having the range hood; the plurality of lighting lamps for lighting under the radio-frequency heating device; and the dimming device provided with the current control device for controlling the luminance of the lighting lamps, the plurality of lighting lamps are connected in series.

With the above-described arrangement, it is possible to provide the arrangement capable of protecting the dimming device from the overcurrent breakage at a reduced cost by preventing the overcurrent which may be generated at the time of the failure of the lighting lamp.

In the case where a semiconductor device such as the TRIAC less resistant against, in particular, the overcurrent is used as the dimming device according to the present invention, the overcurrent with respect to the failure of the lighting lamp can be suppressed to a small value. Thus, even if the inexpensive semiconductor device having a small rating current is used, the radio-frequency heating apparatus with the range hood which has a high reliability and is free from a failure can be provided.

### INDUSTRIAL APPLICABILITY

As described above, it is possible to protect the circuit parts in the dimming device by preventing the overcurrent at the time of the short-circuiting failure in the lighting lamp, and therefore, the present invention is applicable to, in particular, the radio-frequency heating apparatus with the range hood.

### REFERENCE MARKS IN THE DRAWINGS

11 radio-frequency heating apparatus with range hood
12 cooking range
13 range hood
14 intake port
41 first incandescent lamp
42 second incandescent lamp
43 load power source
44 TRIAC
45 photo TRIAC
46 light emitting diode
47 dimming control unit
48 controller power source
49 dimming device

1. A radio-frequency heating apparatus with a range hood comprising:
a radio-frequency heating device having a range hood;
a plurality of lighting lamps for lighting under the radio-frequency heating device; and
a dimming device provided with a current control device for controlling luminance of the lighting lamps, wherein the plurality of lighting lamps are connected in series.

2. The radio-frequency heating apparatus with a range hood according to claim 1, wherein the current control device includes a semiconductor device.

3. The radio-frequency heating apparatus with a range hood according to claim 2, wherein the semiconductor device includes a TRIAC.

4. The radio-frequency heating apparatus with a range hood according to claim 1, wherein a filament of any of the lighting lamps functions as an overcurrent preventing resistance when a filament of at least one of the other lighting lamps is short-circuited.
